(19) United States
(12) Patent Application Publication
(10) Pub. No.: US 2020/0139461 A1
(43) Pub. Date: May 7, 2020

(54) Empty shell capsule removing device for pharmaceutical production line

(71) Applicant: Haiqiu Shu, Weihai City (CN)

(72) Inventor: Haiqiu Shu, Weihai City (CN)

(21) Appl. No.: 16/734,380

(22) Filed: Jan. 5, 2020

(30) Foreign Application Priority Data
Sep. 28, 2019 (CN) 2019109288271

(51) Int. Cl. B23D 33/02; B23D 19/08; B23D 33/10

(52) U.S. Cl. CPC B23D 33/02; B23D 33/10; B23D 19/08

(57) ABSTRACT

The invention discloses a waste air-conditioning compressor recycling processing equipment, which includes a conveying box. The conveying box is provided with a conveying chamber with an opening facing upward. The conveying chamber is provided with a conveying device. Two left and right symmetrical fixing rods are fixedly connected, and a cutting box is fixedly connected to the fixed rods. The cutting box is provided with a cutting cavity with an opening facing downward, and the cutting cavity is provided with a power device. The lower side of the power unit is provided with a lifting device for providing the lifting movement required for cutting. The lower side of the lifting device is provided with a cutting device for cutting the compressor. The right side of the cutting device is provided for quickly clamping and fixing the compressor and the The clamping device for conveying the cut off compressor upper cover plate to the storage place can realize automatic clamping and fixing of the compressor, the installation and fixing process is simple, and the overall processing efficiency is improved.

### CROSS-REFERENCES TO RELATED APPLICATIONS

The present application claims priority from Chinese application No. 2019108855570 filed on Sep. 19, 2019 which is hereby incorporated by reference in its entirety.

### FIELD OF TECHNOLOGY

The invention relates to the field of recovery and treatment for waste air-conditioning compressor, and in particular relates to a recovery and treatment equipment for waste air-conditioning compressor.

### TECHNICAL FIELD

With the continuous improvement of people's daily living standards and a large number of demands, and because of the limited service life of electrical products, the number of waste air conditioners is increasing, because the compressor contains a variety of metals, which has high value and is not recycled It will cause huge environmental pollution problems, so the recycling industry chain has been formed on the market. The key step in the recycling process of air-conditioning compressors is to cut the compressor casing, so that the internal parts of the compressor are recycled. At present, the cutting of compressors is mainly performed manually. Hand-held cutting equipment for cutting is time-consuming, labor-intensive and inefficient, while the current semi-automatic cutting equipment requires manual clamping and fixing of the compressor to perform the cutting process. The degree of automation is insufficient, and the installation and fixing are time-consuming and laborious, making the overall efficiency low. The present invention illustrates a device capable of solving the above problems.

### CONTENT OF THE INVENTION

Technical problem: The current semi-automatic cutting equipment requires manual clamping and fixing of the compressor, which is time-consuming and laborious to install and fix, making the overall efficiency low.

In order to solve the above problems, this example designs a waste air-conditioning compressor recovery processing equipment. The waste air-conditioning compressor recovery processing equipment of this example includes a conveying box, and the conveying box is provided with a conveying cavity whose opening faces upward. The conveying cavity is provided with a conveying device for conveying a compressor. Two left and right symmetrical fixing rods are fixedly connected to the upper end surface of the conveying cavity, and a cutting box is fixedly connected to the fixing rod. A cutting cavity with an opening facing downward is provided in the box, and a power device is provided in the cutting cavity. A lifting device for lifting movement required for cutting is provided on the lower side of the power device, and a cutting device for cutting is provided on the lower side of the lifting device. A cutting device of a compressor, a clamping device is provided on the right side of the cutting device, and the clamping device includes a slide table provided in the cutting cavity, two sliding connections on the upper end surface of the slide table, and left and right A symmetrical wedge-shaped block, a clamping block fixedly connected to the lower end surface of the wedge-shaped block and extending downwardly outside the end surface of the slide table, two fixedly connected to the lower end surface of the slide table and left-right symmetrical Block, the clamping block is located on the side of the stopper near the center of symmetry, a clamping spring connected between the stopper and the clamping block, a pressure rod provided on the upper side of the wedge-shaped block, Two left-right symmetrical tapered blocks that are fixedly connected to the lower end surface of the pressing rod, and the tapered blocks can abut the wedge-shaped block and restrict the movement of the wedge-shaped block, and are fixedly connected to the pressing rod. A slide bar on the lower end surface and extending downward to the outside of the end surface of the slide table, a lifting block fixedly connected to the slide bar and located on the lower side of the slide table, when the slide table moves down, the lift After the block abuts the compressor, the lifting block is pushed upward by the compressor, so that the tapered block is out of contact with the wedge block. Under the action of the clamping spring, the clamping block is moved closer to the center of symmetry. One side is moved to abut the clamping block and the compressor, thereby achieving clamping and fixing of the compressor.

Wherein, the conveying device includes two conveying shafts which are rotatably connected to the left inner wall of the conveying cavity and extend to the right, and the two conveying shafts are symmetrical back and forth, and the conveying shaft on the front side is dynamically connected with a fixed A conveying motor connected to the left inner wall of the conveying cavity, a conveying belt wheel is fixedly connected to the conveying shaft, a conveying belt is connected between the two conveying belt wheels, and two are provided on the upper side of the conveying belt Left and right symmetry are used to hold the clamping block of the compressor. A push rod is fixedly connected to an end surface of the clamping block far from the center of symmetry, and the push rod extends to the side far from the center of symmetry to the outside of the end face of the fixed rod. A limiting block located on the side of the fixed rod away from the center of symmetry is fixedly connected to the push rod, and a tension spring is connected between the limiting block and the fixed rod.

Preferably, the conveying box is provided with a recovery chamber for storing the cut compressor upper cover plate located on the front side of the conveying chamber.

Wherein, the power device includes an auxiliary motor shaft which is rotatably connected to the upper inner wall of the cutting cavity and extends downward, and an auxiliary motor fixedly connected to the upper inner wall of the cutting cavity is connected to the auxiliary motor shaft. A bevel gear located below the auxiliary motor is fixedly connected to the auxiliary motor shaft, a cylinder is rotatably connected to the auxiliary motor shaft, and a spline wheel located in the cylinder is fixedly connected to the auxiliary motor shaft. A spline cylinder is splined on the spline wheel, a sealing plug located on the lower side of the spline wheel is fixedly connected in the spline cylinder, and the spline cylinder is on the upper side of the inner wall of the cylinder An auxiliary tension spring is connected, an electromagnet is fixedly connected to the inner wall of the lower side of the cylinder, an air pump is fixedly connected to the inner wall of the rear side of the cutting cavity, and an air pump is rotatably connected to the cutting cavity to the left. The air pump shaft is fixedly connected with the auxiliary bevel gear meshed with the bevel gear. An air pipe is connected between the air pump and the cylinder, and a pressure relief valve is provided on the air pipe.

Preferably, the transmission ratio between the bevel gear and the auxiliary bevel gear is one to two.

Wherein, the lifting device comprises a piston cylinder fixedly connected to the rear inner wall of the cutting cavity and located on the lower side of the cylinder, a piston cavity is provided in the piston cylinder, and an upper end surface of the piston cavity is fixedly connected to the piston cylinder. A rotation shaft extending upward into the cylinder, and the rotation shaft penetrates the electromagnet and is rotatably connected to the cylinder, and an upper end surface of the rotation shaft is fixedly connected to the cylinder and the electromagnet. The auxiliary spline wheel is provided with an air hole in the rotating shaft to communicate the cylinder with the piston cavity, and the sealing plug can seal the air hole, so that the air hole and the auxiliary The motor shaft is not connected, a piston is slidably connected in the piston cavity, a piston rod that extends downwardly to the outside of the end face of the piston cavity is fixedly connected to the lower end surface of the piston, and the piston and the inner wall of the lower side of the piston cavity A compression spring is connected between them, and a motor slide rail located on the lower side of the piston cavity is fixedly connected to the lower end surface of the piston rod.

Wherein, the cutting device includes a linear motor slidingly connected to the lower end surface of the motor slide rail, the linear motor and the motor slide rail form a linear motor mechanism, and a slide is fixedly connected to the lower end surface of the linear motor. Block, the slider is rotatably connected with a downwardly extending motor shaft, the motor shaft is dynamically connected with a motor fixedly connected to the slider, and the motor shaft is fixedly connected with the lower side of the motor For a cutting wheel of a compressor, a photoelectric switch is fixedly connected to the left end surface of the motor slide rail and the right end surface of the cutting cavity, and the two photoelectric switches correspond to each other.

Wherein, the clamping device includes a fixing block fixedly connected to the rear end surface of the motor slide rail and located on the right side of the linear motor, and an auxiliary cylinder is fixedly connected to the lower end surface of the fixing block, and the auxiliary cylinder An auxiliary air cavity is provided therein, and a sliding plug is slidably connected in the auxiliary air cavity. An auxiliary push rod extending forward to the end of the auxiliary air cavity is fixedly connected to the front end surface of the sliding plug. A connecting shaft located outside the front end surface of the auxiliary air cavity is fixedly connected to the rod, the connecting shaft is rotatably connected to the upper end surface of the slide table, and the connecting shaft is located at the rear side of the wedge block, and the sliding A reset spring is connected between the plug and the inner wall on the front side of the auxiliary air cavity. An air hole with a rearward opening is provided on the inner wall on the rear side of the auxiliary air cavity. A pressure relief valve is provided on the lower end surface of the auxiliary air cavity. A secondary air pipe is connected between the secondary air cavity and the piston cavity. A limit switch that can be contacted with the lifting block is fixedly connected to the lower end surface of the slide table. The internal wall of the front side of the cutting cavity is fixedly connected. The auxiliary fixing rod is located at the front side of the wedge block, and the rear end of the auxiliary fixing rod is fixed. Connected with said wedge block trapezoidal block abuts.

Preferably, the inner diameter of the auxiliary air cavity is smaller than the inner diameter of the piston cavity, and the minimum lifting distance required for the compressor to move the clamping device downward to clamp the compressor with the maximum height can also generate sufficient driving airflow. Drive the slider to the left and right limit positions.

The beneficial effect of the present invention is that the conveying mechanism of the present invention is provided with a guide mechanism. After the operator places the compressor on the conveyor belt, under the action of the guide mechanism, the conveying mechanism can accurately convey the compressor to the clamping mechanism. Side, after that, the lifting mechanism drives the clamping mechanism and cutting mechanism to move down. After the clamping mechanism contacts the compressor, it automatically clamps and fixes the compressor. After that, the cutting mechanism cuts the compressor casing. After the cutting is completed, the clamping mechanism clamps the After the upper cover plate is cut, the lifting mechanism drives the clamping mechanism and the cutting mechanism to move upward and reset. During the upward movement, the clamping mechanism can move forward to convey the upper cover plate into the recycling box, and release the upper cover plate to realize automatic The upper cover is recovered and stored. Therefore, the present invention can automatically clamp and fix the compressor, and the installation and fixing process is simple, so that the overall processing efficiency is improved.

### BRIEF DESCRIPTION OF THE DRAWINGS

For ease of description, the present invention is described in detail by the following specific embodiments and the accompanying drawings.

FIG. 1 is a schematic diagram of the overall structure of a recycling treatment device for a used air-conditioning compressor of the present invention;

FIG. 2 is a schematic structural diagram of the direction “A-A” of FIG. 1;

FIG. 3 is a schematic structural diagram in a direction “B-B” of FIG. 2;

FIG. 4 is a schematic structural diagram in a direction “C-C” of FIG. 1;

FIG. 5 is an enlarged schematic view of the structure at “D” in FIG. 1;

FIG. 6 is an enlarged schematic view of the structure at “E” in FIG. 1;

FIG. 7 is a schematic structural diagram of the “F-F” direction of FIG. 1.

### DETAILED DESCRIPTION OF THE INVENTION

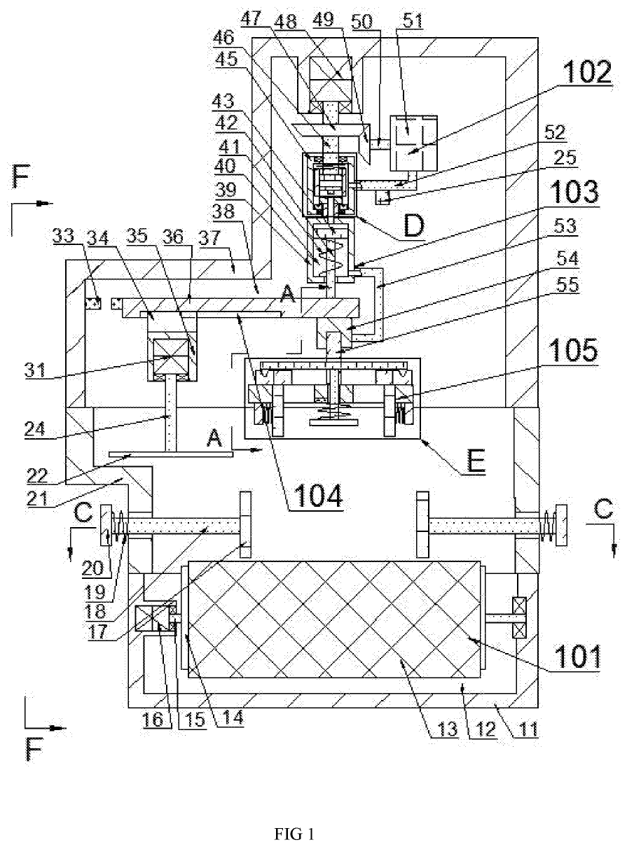

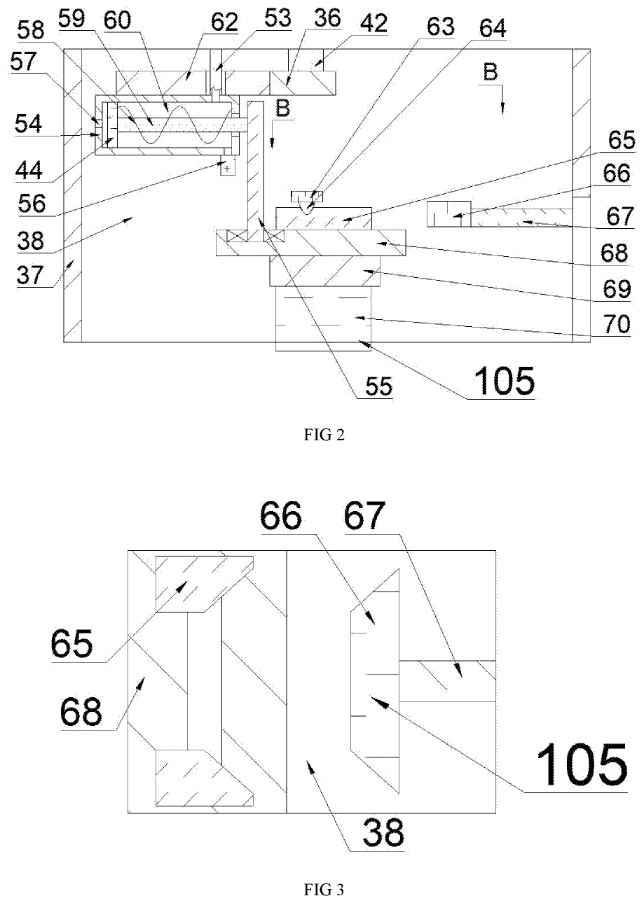

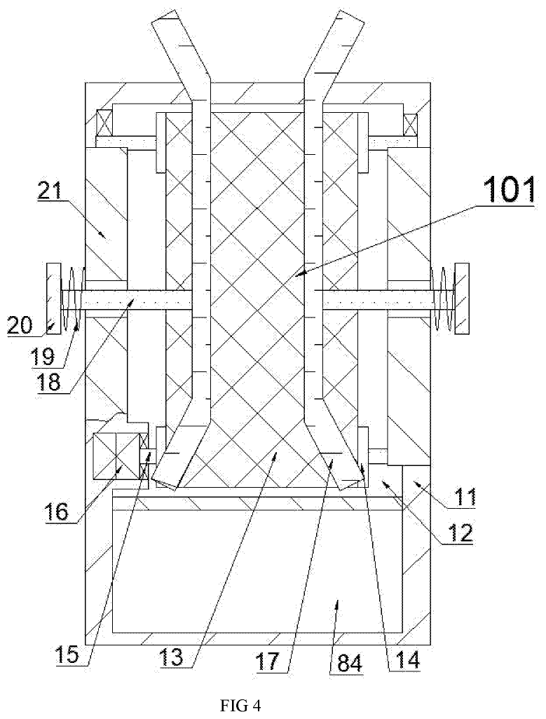

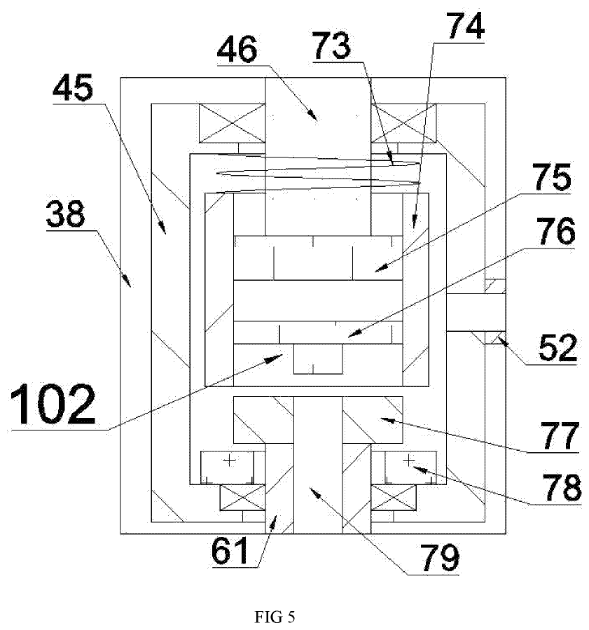

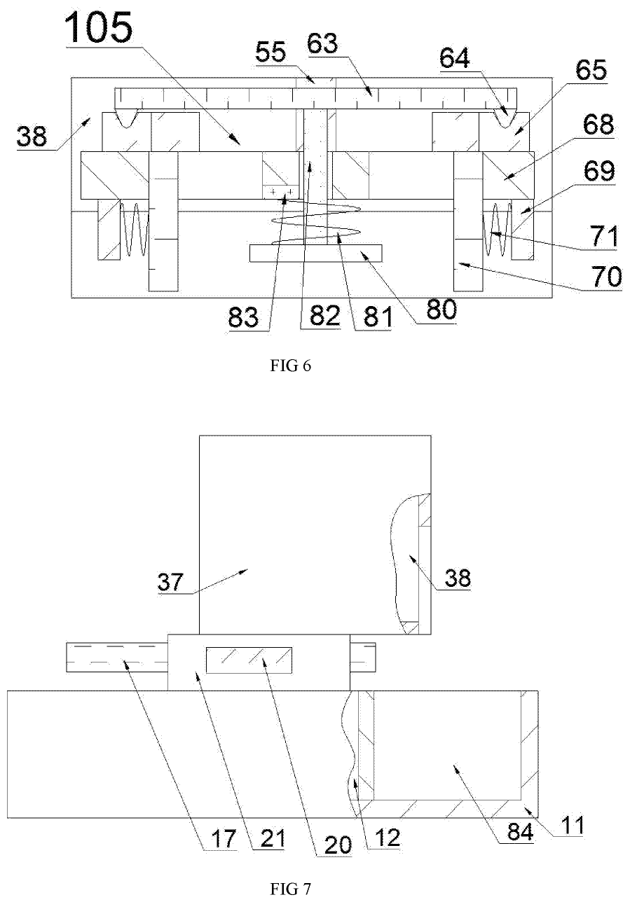

The present invention is described in detail below with reference to FIGS. 1 to 7. For convenience of description, the orientation described below is defined as follows: the up-down, left-right, front-back direction described below is consistent with the up-down, left-right, front-back direction of the proj ection relationship of FIG.

The present invention relates to a waste air-conditioning compressor recovery processing equipment, which is mainly applied to the air-conditioning compressor recovery processing. The present invention will be further described below with reference to the accompanying drawings of the present invention:

The waste air-conditioning compressor recycling processing equipment according to the present invention includes a conveying box 11. The conveying box 11 is provided with a conveying chamber 12 with an opening facing upward, and the conveying chamber 12 is provided with a conveying chamber for conveying the compressor. Device 101, two left-right symmetrical fixing rods 21 are fixedly connected to the upper end surface of the conveying cavity 12, and a cutting box 37 is fixedly connected to the fixing rods 21, and the cutting box 37 is provided with an opening facing downward The cutting cavity 38 is provided with a power device 102 for providing power therein. A lifting device 103 is provided on the lower side of the power device 102 to provide a lifting movement required for cutting. There is a cutting device 104 for cutting a compressor. A clamping device 105 is provided on the right side of the cutting device 104 for fast clamping and fixing of the compressor and can transport the cut compressor upper cover to a storage place. The device 105 includes a slide table 68 disposed in the cutting cavity 38, two left-right symmetrical wedge blocks 65 slidingly connected to the upper end surface of the slide table 68, and fixedly connected to the lower end surface of the wedge block 65. And extend down to said The clamping block 70 outside the end surface of the table 68, two left-right symmetrical stoppers 69 fixedly connected to the lower end surface of the slide table 68, and the clamping blocks 70 are located on the side of the stopper 69 near the center of symmetry A clamping spring 71 connected between the stopper 69 and the clamping block 70, a pressing rod 63 provided on the upper side of the wedge block 65, and two fixedly connected to the lower end surface of the pressing rod 63 The upper and left-right symmetrical tapered block 64 can abut the wedge-shaped block 65 and restrict the wedge-shaped block 65 from moving. It is fixedly connected to the lower end surface of the pressing rod 63 and faces downward. A slide bar 82 extending outside the end surface of the slide table 68, and a lifting block 80 fixedly connected to the slide bar 82 and located on the lower side of the slide table 68. When the slide table 68 moves down, the lifting block 80 After the 80 abuts against the compressor, the lifting block 80 is pushed upward by the compressor, so that the tapered block 64 is out of contact with the wedge block 65. Under the action of the clamping spring 71, the clamping block 70 is moved to a side closer to the center of symmetry, so that the clamping block 70 is in contact with the compressor, thereby achieving clamping and fixing of the compressor.

According to the embodiment, the conveying device 101 is described in detail below. The conveying device 101 includes two conveying shafts 15 which are rotatably connected to the left inner wall of the conveying cavity 12 and extend to the right, and the two conveying shafts 15 Front-to-rear symmetry, the front side of the conveying shaft 15 is dynamically connected with a conveying motor 16 fixedly connected to the left inner wall of the conveying cavity 12, and the conveying shaft 15 is fixedly connected with a conveying belt wheel 14. A conveyor belt 13 is connected between the conveyor belt wheels 14. The upper side of the conveyor belt 13 is provided with two clamping blocks 17 symmetrically for clamping the compressor. A push rod 18 is fixedly connected, and the push rod 18 extends to the side far from the center of symmetry to the outside of the end surface of the fixed rod 21. The push rod 18 is fixedly connected with a limit located on the side of the fixed rod 21 far from the center of symmetry. A tensioning spring 19 is connected between the position block 20 and the limiting block 20 and the fixing rod 21, and the conveying motor 16 can drive the conveying shaft 15 and the conveying belt wheel 14 to rotate, thereby driving all The conveyor belt 13 conveys a compressor, and the clamping block 17 can Compressor guided limit.

Beneficially, the conveying box 11 is provided with a recovery chamber 84 located on the front side of the conveying chamber 12 for storing the cut off upper cover plate of the compressor.

According to the embodiment, the power device 102 will be described in detail below. The power device 102 includes a sub-motor shaft 46 that is rotatably connected to the upper inner wall of the cutting cavity 38 and extends downward. The sub-motor shaft 46 is power-connected. The auxiliary motor 48 is fixedly connected to the inner wall of the upper side of the cutting cavity 38. The auxiliary motor shaft 46 is fixedly connected with a bevel gear 47 located on the lower side of the auxiliary motor 48. The auxiliary motor shaft 46 is rotationally connected. There is a cylinder 45, and a spline wheel 75 located in the cylinder 45 is fixedly connected to the auxiliary motor shaft 46. A spline cylinder 74 is splined to the spline wheel 75, and the spline cylinder 74 is fixed inside. A sealing plug 76 located on the lower side of the spline wheel 75 is connected, and a secondary tension spring 73 is connected between the spline cylinder 74 and the upper inner wall of the cylinder 45. The lower inner wall of the cylinder 45 is fixedly connected. There is an electromagnet 78, an air pump 51 is fixedly connected to the inner wall of the rear side of the cutting cavity 38, and an air pump shaft 50 extending to the left of the cutting cavity 38 is rotatably connected to the air pump 51, and the air pump shaft 50 is fixed to A secondary bevel gear 49 meshed with the bevel gear 47 is connected, and the air pump 51 and An air pipe 52 is connected between the cylinders 45. The air pipe 52 is provided with a pressure relief valve 25. The auxiliary motor 48 drives the auxiliary motor shaft 46 to rotate, and through the bevel gear 47 and the auxiliary The meshing connection of the bevel gear 49 can drive the air pump 51 to generate compressed air.

Advantageously, the transmission ratio between the bevel gear 47 and the auxiliary bevel gear 49 is one to two.

According to the embodiment, the lifting device 103 is described in detail below. The lifting device 103 includes a piston cylinder 39 fixedly connected to the rear inner wall of the cutting cavity 38 and located below the cylinder 45. The piston cylinder 39 is inside the piston cylinder 39. A piston chamber 40 is provided. A rotary shaft 61 extending upward into the cylinder 45 is fixedly connected to an upper end surface of the piston chamber 40, and the rotary shaft 61 penetrates the electromagnet 78 and is rotatably connected to the cylinder 45. An auxiliary spline wheel 77 located in the cylinder 45 and above the electromagnet 78 is fixedly connected to the upper end surface of the rotation shaft 61. The rotation shaft 61 is provided with the cylinder 45 and the piston cavity. 40 communication air holes 79, and the sealing plug 76 can seal the air transmission holes 79, so that the air transmission holes 79 are not connected with the auxiliary motor shaft 46, and a piston is slidably connected in the piston cavity 40 43, a piston rod 42 extending downwardly to the outside of the end face of the piston cavity 40 is fixedly connected to the lower end face of the piston 43, and a compression spring 41 is connected between the piston 43 and the inner wall below the piston cavity 40, The lower end surface of the piston rod 42 is fixedly connected to the lower side of the piston cavity 40 The motor slide 36, the compressed air generated by the air pump 51 is delivered into the cylinder 45 through the air pipe 52, and is delivered into the piston cavity 40 through the air delivery hole 79 to drive the piston 43 up and down, Thus, lifting movement is realized.

According to the embodiment, the cutting device 104 will be described in detail below. The cutting device 104 includes a linear motor 34 slidingly connected to the lower end surface of the motor slide rail 36. The linear motor 34 and the motor slide rail 36 constitute A linear motor mechanism. A slider 35 is fixedly connected to the lower end surface of the linear motor 34. The slider 35 is rotatably connected to a motor shaft 24 extending downward. The motor shaft 24 is fixedly connected to the motor shaft 24 by power. The motor 31 on the slider 35 is fixedly connected to the motor shaft 24 with a cutting wheel 22 located on the lower side of the motor 31 and used to cut the compressor. The left end surface of the motor slide rail 36 and the cutting A photoelectric switch 33 is fixedly connected to the right end surface of the cavity 38, and the two photoelectric switches 33 correspond to each other. The linear motor 34 drives the slider 35 to move along the motor slide rail 36, and the motor 31 The cutting wheel 22 is driven to rotate to realize a cutting compressor.

According to the embodiment, the clamping device 105 is described in detail below. The clamping device 105 includes a fixing block 62 fixedly connected to the rear end surface of the motor slide rail 36 and located on the right side of the linear motor 34. A sub-cylinder 54 is fixedly connected to the lower end surface of the fixing block 62. The sub-cylinder 54 is provided with a sub-air cavity 60, and a sliding plug 44 is slidably connected to the sub-air cavity 60. The auxiliary push rod 59 is fixedly connected to extend forward to the outside of the end surface of the auxiliary air cavity 60. The auxiliary push rod 59 is fixedly connected to a connecting shaft 55 located outside the front end surface of the auxiliary air cavity 60. The connection The shaft 55 is rotatably connected to the upper end surface of the slide table 68, and the connection shaft 55 is located at the rear side of the wedge block 65. A return spring is connected between the slide plug 44 and the front inner wall of the auxiliary air cavity 60. 58. A rear-side air hole 57 is provided on the rear inner wall of the auxiliary air cavity 60. A pressure relief valve 56 is provided on a lower end surface of the auxiliary air cavity 60. The auxiliary air cavity 60 and the piston cavity 40 A secondary air pipe 53 is connected to each other, and a limit switch 83 that can contact the lifting block 80 is fixedly connected to the lower end surface of the slide table 68. A secondary fixing rod 67 located on the front side of the wedge block 65 is fixedly connected to the inner wall of the front side of the cutting cavity 38, and a trapezoidal block that is in contact with the wedge block 65 is fixedly connected to the rear end of the auxiliary fixing rod 67. 66. When the piston 43 is moved upward and reset, the negative pressure generated in the piston chamber 40 is transmitted to the auxiliary air chamber 60 through the auxiliary air pipe 53 to drive the slide plug 44 to move forward to achieve conveyance. Cover movement.

Beneficially, the inner diameter of the auxiliary air cavity 60 is smaller than the inner diameter of the piston cavity 40, and the minimum lifting distance required for the compressor 43 to move the clamping device 105 downward to clamp the compressor of the maximum height can also produce It is enough to drive the airflow to move the sliding plug 44 to the left and right limit positions.

The following describes in detail the use steps of a waste air-conditioning compressor recovery processing equipment in conjunction with FIG. 1 to FIG. 7:

At the beginning, the pressure relief valve 56 is in the open state, the slide plug 44 and the connecting shaft 55 are at the rear limit, the wedge block 65 is at the limit away from the center of symmetry, and the cone block 64 abuts the wedge block 65. Under the action of 81, the pressure lever 63 and the lifting block 80 are located at the lower limit. The limit switch 83 is not in contact with the lifting block 80. The linear motor 34 is located at the left limit. The two photoelectric switches 33 correspond to each other. Under the action, the spline cylinder 74 is located at the upper limit position, and the spline cylinder 74 and the auxiliary spline wheel 77 are not splined. Under the action of the tension spring 19, the clamping block 17 is located at the limit near the center of symmetry. The iron 78 is not energized, and the pressure relief valve 25 is closed.

During operation, the waste compressor is placed on the conveyor belt 13 and the conveyor motor 16 is started. The conveyor motor 16 drives the conveyor belt 13 to move backward through the conveyor shaft 15 on the front side and the conveyor wheel 14 on the front side, while holding the block 17 Under the guidance limit, the compressor moves to the lower side of the sliding table 68, and then the conveying motor 16 stops and starts the auxiliary motor 48. The auxiliary motor 48 drives the bevel gear 47 through the auxiliary motor shaft 46, and the bevel gear 47 drives the auxiliary gear through the meshing connection. The bevel gear 49 and the air pump shaft 50 are rotated, so that the air pump 51 works to produce airflow. The airflow is delivered into the cylinder 45 through the air pipe 52 and into the piston cavity 40 through the air delivery hole 79 to drive the piston 43 down. The piston 43 passes through the piston rod 42, The motor slide 36 drives the motor slide 36, the fixing block 62, the air hole 57, the connecting shaft 55, and the slide table 68 to move downward. At the same time, the air flow in the piston chamber 40 is transmitted to the auxiliary air chamber 60 through the auxiliary air pipe 53 and passes through the pressure relief valve. 56 is discharged. When the compressor is in contact with the lifting block 80, the compressor moves the lifting block 80, the sliding rod 82 and the pressing rod 63 up, so that the tapered block 64 and the wedge block 65 are disengaged and abutted, under the action of the clamping spring 71 , The clamping block 70 moves to the side near the center of symmetry Hold the fixed compressor, at the same time, the lifting block 80 is in contact with the limit switch 83, the limit switch 83 is triggered, the electromagnet 78 is energized to attract the spline cylinder 74, the sealing plug 76 closes the gas transmission hole 79, and the spline cylinder 74 and the vice The spline wheel 77 is splined. The excess air generated by the air pump 51 is discharged by opening the pressure relief valve 25. The auxiliary motor shaft 46 drives the spline cylinder 74 through the spline connection of the spline wheel 75 and the spline cylinder 74 to rotate the spline cylinder. 74 spline connection drives the spline wheel 77 and the rotating shaft 61 to rotate. The rotating shaft 61 drives the piston cylinder 39 to rotate. The piston cylinder 39 drives the motor slide 36 through the piston 43 and the piston rod 42. At the same time, the linear motor 34 starts to move closer to the center of symmetry. When one side moves and feeds, the motor 31 starts to drive the motor shaft 24 and the cutting wheel 22 to rotate to realize the cutting of the compressor casing. After the cutting is completed, the clamping block 70 clamps the upper cover of the compressor that has been cut to release the pressure. The valve 56 is closed, the motor 31 stops, the linear motor 34 moves to the side away from the center of symmetry and resets, the auxiliary motor 48 reverses, the electromagnet 78 loses power, and the auxiliary tension spring 73 resets the spline cylinder 74 to move upward, and the air pump 51 generates a negative Press to reset the piston 43 to move up, while the piston 43 moves up The generated negative pressure drives the slider 44 forward through the auxiliary air pipe 53. When the trapezoidal block 66 abuts the wedge block 65, the trapezoidal block 66 pushes the wedge block 65 to move to both sides to reset, so that the clamping block 70 and the upper cover plate When disengaged, the upper cover plate falls into the recovery chamber 84, and at the same time, the spring 81 causes the lifting block 80 to move downward and reset, the cone block 64 and the wedge block 65 abut again, and then the pressure relief valve 56 opens, and the return spring 58 causes the slide plug 44 moves backward to reset, after the motor slide rail 36 rotates to two photoelectric switches 33 corresponding again, the auxiliary motor 48 stops to complete the reset of the entire device.

The beneficial effect of the present invention is that the conveying mechanism of the present invention is provided with a guide mechanism. After the operator places the compressor on the conveyor belt, under the action of the guide mechanism, the conveying mechanism can accurately convey the compressor to the clamping mechanism. Side, after that, the lifting mechanism drives the clamping mechanism and cutting mechanism to move down. After the clamping mechanism contacts the compressor, it automatically clamps and fixes the compressor. After that, the cutting mechanism cuts the compressor casing. After the cutting is completed, the clamping mechanism clamps the After the upper cover plate is cut, the lifting mechanism drives the clamping mechanism and the cutting mechanism to move upward and reset. During the upward movement, the clamping mechanism can move forward to convey the upper cover plate into the recycling box, and release the upper cover plate to realize automatic The upper cover is recovered and stored. Therefore, the present invention can automatically clamp and fix the compressor, and the installation and fixing process is simple, so that the overall processing efficiency is improved.

In the above manner, those skilled in the art can make various changes according to the working mode within the scope of the present invention.

1. A waste air-conditioning compressor recycling processing equipment, including a transmission box; the conveying box is provided with a conveying cavity with an upward opening therein, and a conveying device for conveying a compressor is provided in the conveying cavity. Two left and right symmetrical fixing rods are fixedly connected to the upper end surface of the conveying cavity. A cutting box is fixedly connected to the fixing rod, the cutting box is provided with a cutting cavity with an opening facing downward, a power device is arranged in the cutting cavity, and a lifting movement required for cutting is provided on the lower side of the power device. A lifting device is provided on the lower side of the lifting device, a cutting device for cutting the compressor is provided on the right side of the cutting device, and a clamping device is provided on the right side of the cutting device. The clamping device includes a slide table provided in the cutting cavity, two Left and right symmetrical wedge-shaped blocks slidably connected to the upper end surface of the slide table, clamping blocks fixedly connected to the lower end surface of the wedge block and extending downward to the outside of the end surface of the slide table, two fixed connections A left-right symmetrical stop on the lower end surface of the slide table, and the clamping block is located on the side of the stop near the center of symmetry, and is connected to the clamping between the stop and the clamping block. Spring, arranged on the wedge block Pressure bar, two left-right symmetrical tapered blocks that are fixedly connected to the lower end surface of the bar, and the tapered blocks can abut the wedge-shaped block and restrict the wedge-shaped block from moving and are fixedly connected to The slide bar on the lower end surface of the pressing rod and extending downward to the outside of the end surface of the slide table, the lifting block fixedly connected to the slide bar and located on the lower side of the slide table, when the slide table moves down After the lifting block is brought into contact with the compressor, the lifting block is pushed upward by the compressor, so that the tapered block is out of contact with the wedge-shaped block. Under the action of the clamping spring, the clamping block Moving to the side close to the center of symmetry, the clamping block is brought into contact with the compressor, thereby achieving clamping and fixing of the compressor.

2. The recycling and processing equipment for a used air-conditioning compressor according to claim 1, wherein the conveying device comprises two conveying shafts which are rotatably connected to the left inner wall of the conveying cavity and extend to the right, and two The conveying shaft is symmetrical back and forth, and a conveying motor fixedly connected to the left inner wall of the conveying cavity is dynamically connected to the conveying shaft on the front side, and two conveying belt wheels are fixedly connected to the conveying shaft. A conveyor belt is connected between the pulleys. The upper side of the conveyor belt is provided with two clamping blocks symmetrically for clamping the compressor, and a push rod is fixedly connected to an end surface of the clamping block away from the center of symmetry. The push rod extends to the side far from the center of symmetry to the outside of the end face of the fixed rod, and a limit block located on the side of the fixed rod far from the center of symmetry is fixedly connected to the push rod. A tension spring is connected between the fixing rods.

3. The recycling and processing equipment for a waste air-conditioning compressor according to claim 2, characterized in that: the conveying box is provided with a recovery cavity for storing the cut compressor upper cover plate located on the front side of the conveying cavity.

4. The recycling and processing equipment for a used air-conditioning compressor according to claim 1, wherein the power device comprises a sub-motor shaft which is rotatably connected to the upper inner wall of the cutting cavity and extends downward, and the sub-motor A secondary motor fixedly connected to the upper inner wall of the cutting cavity is connected to the shaft, a bevel gear located on the lower side of the secondary motor is fixedly connected to the shaft, and a cylinder is rotatably connected to the secondary motor shaft. A spline wheel located in the cylinder is fixedly connected to the auxiliary motor shaft, a spline cylinder is splined to the spline wheel, and a spline cylinder is fixedly connected to the spline wheel under the spline wheel. A sealing plug on the side, a secondary tension spring is connected between the spline cylinder and the upper inner wall of the cylinder, an electromagnet is fixedly connected to the lower inner wall of the cylinder, and an inner wall is fixedly connected to the rear side of the cutting cavity An air pump is rotatably connected with an air pump shaft extending to the left in the cutting cavity. The air pump shaft is fixedly connected with an auxiliary bevel gear which is meshed with the bevel gear. Connected to each other with trachea a pressure relief valve is provided on the air pipe.

5. The recycling and processing equipment for a used air-conditioning compressor according to claim 4, wherein the transmission ratio between the bevel gear and the auxiliary bevel gear is one to two.

6. The recycling and processing equipment for a used air-conditioning compressor according to claim 4, wherein the lifting device comprises a piston cylinder fixedly connected to an inner wall on the rear side of the cutting cavity and located on the lower side of the cylinder. A piston cavity is provided in the piston cylinder, and a rotating shaft extending upward into the cylinder is fixedly connected to the upper end surface of the piston cavity, and the rotating shaft penetrates the electromagnet and is rotatably connected with the cylinder. An auxiliary spline wheel located in the cylinder and on the upper side of the electromagnet is fixedly connected to the side end surface, and an air hole is provided in the rotating shaft to communicate the cylinder with the piston cavity, and the seal A plug can seal the air delivery hole, so that the air delivery hole is not in communication with the auxiliary motor shaft. A piston is slidably connected in the piston cavity, and a lower end surface of the piston is fixedly connected to extend downward to the piston. A piston rod outside the end face of the piston cavity, a compression spring is connected between the piston and the inner wall of the lower side of the piston cavity, and a motor slide rail located at the lower side of the piston cavity is fixedly connected to the lower end face of the piston rod.

7. The recycling and processing equipment for a used air-conditioning compressor according to claim 6, wherein the cutting device comprises a linear motor slidingly connected to a lower end surface of the motor slide rail, and the linear motor and the motor The slide rail constitutes a linear motor mechanism. A slider is fixedly connected to the lower end surface of the linear motor. The slider is rotatably connected with a downwardly extending motor shaft. The motor shaft is dynamically connected with the sliding shaft. The motor on the block is fixedly connected to the motor shaft with a cutting wheel located on the lower side of the motor and used to cut the compressor. The left end surface of the motor slide rail and the right end surface of the cutting cavity are fixedly connected. Photoelectric switches, and two of the photoelectric switches correspond.

8. The recycling and processing equipment for a used air-conditioning compressor according to claim 7, wherein the clamping device comprises a fixing block fixedly connected to the rear end surface of the motor slide rail and located on the right side of the linear motor. A secondary cylinder is fixedly connected to the lower end surface of the fixed block, and a secondary air cavity is provided in the secondary cylinder. A sliding plug is slidably connected to the secondary air cavity. A secondary push rod extending forwardly outside the end face of the secondary air cavity, a connecting shaft located outside the front end face of the secondary air cavity is fixedly connected to the auxiliary push rod, and the connection shaft is connected to the upper end face of the slide table Rotating connection, and the connecting shaft is located on the rear side of the wedge block, a return spring is connected between the sliding plug and the inner wall on the front side of the auxiliary air cavity, and the inner wall on the rear side of the auxiliary air cavity is provided with an opening facing backward A vent hole, a pressure relief valve is provided on the lower end surface of the auxiliary air cavity, an auxiliary air pipe is connected between the auxiliary air cavity and the piston cavity, and a lower end surface of the slide table is fixedly connected with The limit switch contacted by the lifting block is fixed on the inner wall on the front side of the cutting cavity A auxiliary fixing rod located at the front side of the wedge-shaped block is connected, and a rear end of the auxiliary fixing rod is fixedly connected with a trapezoidal block that can abut the wedge-shaped block.

9. The recycling and processing equipment for a used air-conditioning compressor according to claim 8, characterized in that: the inner diameter of the auxiliary air cavity is smaller than the inner diameter of the piston cavity, and the downward movement of the piston drives the clamping device to move downward to clamp the largest The minimum lifting distance required for a compressor of a high height can also generate enough to drive the air flow to move the slider to the left and right limit positions.
